(19) United States
(12) Patent Application Publication
(10) Pub. No.: US 2012/0047330 A1
(43) Pub. Date: Feb. 23, 2012

(54) I/O EFFICIENCY OF PERSISTENT CACHES IN A STORAGE SYSTEM

(75) Inventors: Stephen Rago, Warren, NJ (US); Cristian Ungureanu, Princeton, NJ (US)

(73) Assignee: NEC Laboratories America, Inc., Princeton, NJ (US)

(21) Appl. No.: 12/858,974

(22) Filed: Aug. 18, 2010

(51) Int. Cl. G06F 12/08; G06F 12/00

(52) U.S. Cl. 711/133; 711/118; 711/E12.001; 711/E12.022

(57) ABSTRACT

A system and method are disclosed for improving the efficiency of a storage system. At least one application-oriented property is associated with data to be stored on a storage system. Based on the at least one application-oriented property, a manner of implementing at least one caching function in the storage system is determined. Data placement and data movement are controlled in the storage system to implement the at least one caching function.

### BACKGROUND

1. Technical Field

The present invention relates to improving the efficiency of a storage system including a persistent caching component, and more particularly, to selecting an appropriate storage component for storing data based on the characteristics of an application writing the data and the actual data itself.

2. Description of the Related Art

Conventional storage systems may comprise several different storage components that each provide different advantages with respect to storing data. However, these systems do not efficiently select the best storage component for storing a particular piece of data. This is because these storage systems neither consider the characteristics of the data when selecting a component for storing the data, nor the characteristics of the application storing the data.

### SUMMARY

In accordance with the present principles, a method is disclosed for improving the efficiency of a storage system. At least one application-oriented property is associated with data to be stored in a storage system. Based on the at least one application-oriented property, a manner of implementing at least one caching function in the storage system is determined. The storage of data in the storage system is controlled to implement the at least one caching function.

In accordance with the present principles, a system is also disclosed for improving the efficiency of a storage system. A property specifier associates at least one application-oriented property with data to be stored on a storage system. A cache manager determines a manner for implementing at least one caching function in the storage system based on the at least one application-oriented property, and controls the storage of data in the storage system to implement the at least one caching function.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a block/flow diagram illustrating an exemplary architecture for a storage system according to one embodiment of the present principles.

FIG. 2 is a block/flow diagram illustrating an exemplary architecture for a storage system in accordance with another embodiment of the present principles.

FIG. 3 is a block/flow diagram illustrating an exemplary method for improving the efficiency of a storage system in accordance with one embodiment of the present principles.

FIG. 4 is a block/flow diagram illustrating an exemplary method for improving the efficiency of a storage system in accordance with another embodiment of the present principles.

### DETAILED DESCRIPTION OF PREFERRED EMBODIMENTS

In accordance with the present principles, a system and method are provided for optimizing the placement of data among storage system components, such as a persistent cache. A storage system may comprise more than one type of storage device. For example, it may include both a large, slow persistent storage (LSPS) component that is used as a backing store and a small, fast persistent storage (SFPS) component which is used as a persistent cache. An LSPS device, such as a redundant array of independent disks (RAID) or content addressable storage (CAS) device, tends to be “slow” in the sense that accesses to the LSPS exhibit high latency when compared to the SFPS. Although the LSPS is slow, it may be capable of high throughput if it can process many I/O requests in parallel. In contrast, the SFPS is optimized to provide low latency. Exemplary SFPS devices include solid state drives (SSDs) or nonvolatile random access memories (NVRAM). It should be noted that the description of these components as being slow/fast or small/large is relative. For example, a RAID array is relatively small and fast (i.e., an SFPS) when compared with a tape library which is relatively large and slow (i.e., an LSPS).

An SFPS may be used as a persistent cache for the LSPS. In serving as a cache, the perceived latency associated with writing data to the LSPS can be reduced because the user or application does not have to wait for the information, which is to be stored on the LSPS, to actually be written to the LSPS. Rather, such information can be stored in the SFPS (which is optimized to reduce latency) and written to the LSPS either at the same time or at a later time.

The efficiency and performance of a storage system is largely dependent upon the manner in which a cache is managed. Conventional cache systems anticipate the future I/O requests based on the requests observed in the past, such as frequency of access to data, last time of access to data, etc. For example, if a block of data was not accessed recently, the caching system may assume that the block of data will not be accessed in the near future. In this case, the block can be evicted from the cache. While evicting data from the cache consumes the bandwidth to the backing store, it also frees up space for other blocks in the cache. A caching scheme that accurately anticipates future I/O requests can make better decisions with regard to caching functions (e.g., with respect to data caching, write-back, and eviction).

In accordance with the present principles, the efficiency of a storage system can be improved by identifying or inferring certain “application-oriented properties” that may be used to anticipate future I/O requests. As used herein the phrase “application-oriented property” refers to a characteristic or trait of an application or of the data being stored by an application. For example, exemplary application-oriented properties may indicate whether data is transient or whether data is part of a stream. As another example, an application-oriented property may indicate a data format that is used by an application. The storage scheme described herein uses these application-oriented properties to decide how data should be cached in a storage system to improve the overall efficiency of the storage system.

Conventional systems do not contemplate using the characteristics or traits of either the data being stored or of the application storing the data when deciding how to perform caching functions. Rather, conventional systems only consider information that is obtained by the storage system without knowledge of the application (e.g., the frequency of access to the data, the time of last access to the data, least recently used data) in determining how caching functions should be implemented. For the purposes of the description herein, the phrase “application-oriented properties” does not encompass these conventional access-oriented considerations.

In particularly useful embodiments of the present principles, determining whether the data being stored is transient (i.e., whether the data is short-lived or will be deleted in the near future) and whether the data is part of a data stream (i.e., whether the data comprises a number of blocks that are accessed a single time in quick succession) can be used to improve the efficiency of the storage system. Using this information, an appropriate storage component (e.g., an LSPS or an SFPS) can be selected for storing the data of a particular application.

Given the ephemeral nature of transient data, there is an opportunity to optimize a storage system if the system avoids writing the transient data to the LSPS, but rather stores this data exclusively in the SFPS until it has been deleted. Avoiding the storage of transient data in the LSPS saves bandwidth in the storage system and reduces the latency associated with accessing this data when it is needed (which is likely to be shortly after it is written).

For example, consider an application which writes a log of tasks to persistent storage that are to be read and executed by a second application. In such a producer-consumer relationship, once the log is read by the second application and the application has acted on the contents, there is no need to retain the log data in the storage system. Thus, the performance of the storage system can be improved if the system avoids writing the log data to the LSPS, and stores it instead exclusively in the SFPS until it has been read, processed, and deleted.

On the other hand, if it is determined that the data being stored in the storage system is part of a large stream or large portion of data (e.g., data from a video streaming application, archiving application, or back-up application), the storage system may assume that the application won't benefit from caching the data in the SFPS. In this case, it may be advantageous to store this data exclusively in the LSPS to avoid wasting the resources of the SFPS, which can be utilized to improve the performance of other applications (e.g., applications which are using the storage system to store transient data or whose performance can be significantly improved by reducing the latencies associated with I/O operations).

For example, consider the case where a backup application is writing a large stream of data to the storage system. If the stream was written to the SFPS, the bandwidth of the SFPS would be wasted without any, or only a limited, benefit to the backup application. The stream would most likely consume the entire contents of the SFPS and overwrite any information that was stored thereon. This would waste bandwidth and destroy the cached contents of the SFPS. Thus, by storing the stream in the LSPS only, the SFPS can be used more effectively and the overall performance of the storage system can be improved.

In view of the foregoing, the present principles provide for a manner of identifying and/or determining the application-oriented properties of data written to a storage system. In one embodiment, an application explicitly annotates the data with flags that identify the application-oriented properties or attributes of the data. For example, an application may annotate data with two different types of flags, where one flag indicates that the data is transient, and the other indicates that the data is part of a large sequential stream of data. By annotating the data with flags that indicate the presence of certain data attributes, the storage system can determine whether the data should be stored in the SFPS, the LSPS, or both.

In another embodiment, the application does not annotate the data with flags or provide any other means of identifying the attributes of the data. Rather, the data is analyzed by a specialized component of the storage system which can infer or determine whether the data includes certain application-oriented properties (e.g., whether the data is transient or is part of a large stream of data). This may be accomplished by scanning write requests for certain information or by inferring the presence of certain attributes based on the format of the data. By determining or assuming that the data includes certain properties, the storage system can decide whether it would be better to store the data in the SFPS, the LSPS, or both (similar to the case of explicit flags).

It should be noted that the inferences drawn by the storage system are not required to be 100% accurate for the system to derive benefits. For example, consider the case where some blocks that are part of a large stream of data are not identified as such and are therefore written to the SFPS. It may not be advantageous to write this data to the SFPS. However, as long as some streaming writes are correctly identified, those blocks will not be written to the SFPS, thus conserving the I/O bandwidth and the storage space of the SPFS.

Embodiments described herein may be entirely hardware, entirely software or including both hardware and software elements. In a preferred embodiment, the present invention is implemented in software, which includes but is not limited to firmware, resident software, microcode, etc.

Embodiments may include a computer program product accessible from a computer-usable or computer-readable medium providing program code for use by or in connection with a computer or any instruction execution system. A computer-usable or computer-readable medium may include any apparatus that stores, communicates, propagates, or transports the program for use by or in connection with the instruction execution system, apparatus, or device. The medium can be magnetic, optical, electronic, electromagnetic, infrared, or semiconductor system (or apparatus or device) or a propagation medium. The medium may include a computer-readable medium such as a semiconductor or solid state memory, magnetic tape, a removable computer diskette, a random access memory (RAM), a read-only memory (ROM), a rigid magnetic disk or an optical disk, etc.

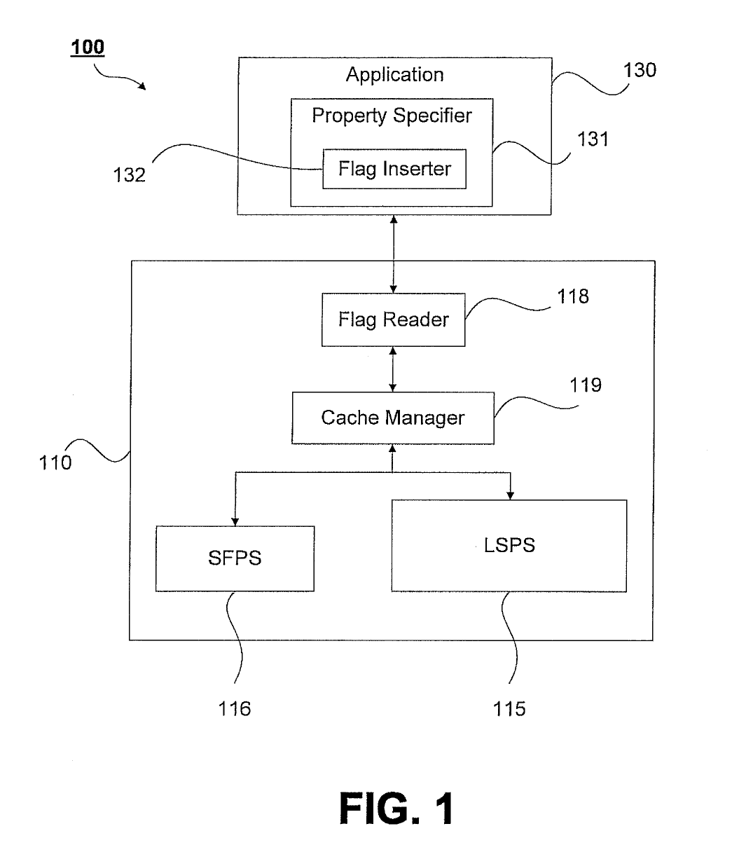

Referring now to the drawings in which like numerals represent the same or similar elements and initially to FIG. 1, an exemplary architecture for a storage system 100 is illustratively depicted in accordance with one embodiment of the present principles. As shown therein, an application 130 stores data in a storage system 110. The application 130 may be executing locally on a computer which comprises storage system 110, or may be executing on a client machine that is coupled to a server or other device (e.g., via a network) which comprises storage system 110.

The storage system 110 includes two storage components: SFPS 116 and LSPS 115. The SFPS 116 relates to a storage device, such as a solid state drive (SSD) or nonvolatile random access memory (NVRAM), which has relatively low I/O latency. The LSPS 115 is relatively slow when compared to the SFPS 116 in terms of latency, but may be capable of high throughput since it might be able to process many I/O requests in parallel. The LSPS 115 may comprise a RAID array including conventional hard disks, a content addressable storage (CAS) device, a backing storage device or other similar devices. In general, the LSPS 115 could be any form of storage, as long as the access time exhibits higher latency than the SFPS 116. Although it is not necessary, the LSPS 115 is depicted as including a greater amount of storage than the SFPS 116. This is practical since the storage of an SFPS 116 device is generally more costly in comparison to the storage of the LSPS 115.

In the embodiment disclosed in FIG. 1, application 130 includes a property specifier 131 which indicates whether the data to be stored on storage system 110 includes certain properties, including application-oriented properties. More specifically, the property specifier 131 uses a flag inserter 132 to annotate the data with flags that indicate whether the data includes certain properties before application 130 issues the request to store data in the storage system 110. In certain embodiments, the flag inserter 132 may automatically mark the data with flags. The flags associated with the data by flag inserter 132 may indicate the presence of a variety of different application-oriented properties including, but not limited to, whether the data is transient, whether the data is part of a large sequential stream (e.g., large with respect to the size of SFPS 116), whether the application has an interest in low latency, etc.

In one particularly useful embodiment, flag inserter 132 may annotate the data with two different flags. One flag indicates whether or not the data is transient or short-lived, while the other indicates whether or not the data is part of a large stream of data. After the flag inserter 132 has annotated the data with the appropriate flags, the data is forwarded to the storage system 110. A flag reader 118 located at the storage system 110 can then read or analyze these flags to determine which attributes are present in the data. Although it is not depicted in FIG. 1, flag reader 118 may be part of the cache manager 119.

Depending upon which application-oriented properties are identified, cache manager 119 will determine an efficient manner of implementing the caching functions in storage system 110. The cache manager 119 may use the identified properties to select a component(s) (e.g., the SFPS 116, the LSPS 115, or both) for storing the data, to determine when data stored in SFPS 116 is to be written to LSPS 115, or to determine when data should be evicted from the SFPS 116 (e.g., to influence policies which determine when old or unused data is to be deleted from SFPS 116). For example, in selecting a device, data which has been marked with a flag indicating that it is part of a stream will likely be stored in the LSPS 115, while data which has been marked with a flag indicating that the data is transient will likely be stored in the SFPS 116.

These two attributes (i.e., transiency and streaming) are particularly useful in determining whether to store data in either the SFPS 116 or the LSPS 115. Identifying data as short-lived or transient permits the storage system 110 to avoid wasting bandwidth associated with storing this data in the LSPS 115. Identifying data as streaming data avoids flooding the SFPS 116 with large quantities of streaming data and consuming the resources of the SFPS 116, which can be used more effectively to store other data.

Conventional systems often use the SFPS 116 as a cache for the LSPS 115 regardless of whether the data is part of a large stream or not. In doing so, the contents of the SFPS 116 are overwritten and the resources of the SFPS 116 are wasted on the streaming application which receives little or no benefit from using the SFPS 116 storage as a cache. Thus, by determining whether data to be stored in storage system 110 constitutes streaming data before it is stored, the performance and efficiency of the system can be significantly improved.

There may be instances where streaming data may be stored in the SFPS 116 and transient data will be stored in the LSPS 115. For example, if the storage of the SFPS 116 is approaching maximum capacity, a cache replacement policy of the SFPS 116 may decide that room is needed. As a result, transient data stored on the SFPS 116 may be written to the LSPS 115.

Also, consider the situation where data has been flagged as pertaining to both transient and streaming data. In this case, the storage system 110 may automatically choose either the SFPS 116 or the LSPS 115 as the storage component to use. Alternatively, the storage system 110 may weigh a number of factors to determine which component should be used to store the data. For example, factors may be considered which relate to the amount of data in the stream, how long the data is likely to reside in the storage system before being read and deleted, how many active streams are sharing the storage system, etc.

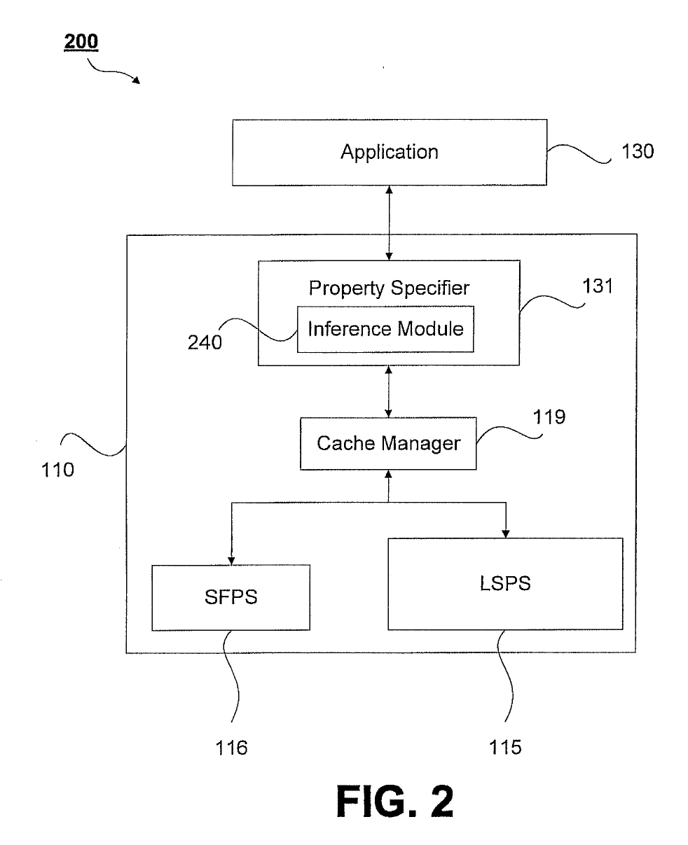

Referring to FIG. 2, an alternate configuration 200 is provided for a storage system according to another embodiment of the present invention. Similar to the embodiment described in FIG. 1, an application 130 stores data in a storage system 110 which comprises the SFPS 116 and the LSPS 115. This embodiment also has a property specifier 131 which indentifies or determines the presence of application-oriented properties and other attributes. However, unlike the embodiment disclosed in FIG. 1, the property specifier 131 does not annotate the data being stored in the storage system 110 with flags at the application 130. Rather, the property specifier 131 is located at the storage system 110 and includes an inference module 240 which can deduce or determine whether the data includes particular properties.

The inference module 240 indicates or infers the presence of particular attributes in data after the application 130 has issued a request to write data to storage system 110. More specifically, the inference module 240 in this embodiment may scan I/O requests for particular characteristics to make assumptions or determinations as to whether the data being stored includes certain attributes. Similarly, the inference module 240 may analyze the data to determine the format that an application is using for the data. Based on the format of the data, it may be assumed that data includes certain properties.

For example, to determine whether the data being stored is transient, the inference module 240 may search the data for particular identifiers which may indicate whether the data belongs to a log. As another example, in determining whether data is likely to be streaming, the inference module 240 may keep a running count of the total amount of data written to a particular stream and determine whether the amount is above or below certain thresholds (e.g., such as a minimum amount of data written within a given time period). Based on this information, the inference module 240 may infer that the data is part of a stream. Similarly, the inference module 240 may analyze data to determine the format of the data. Based on the format of the data, it may be assumed that data includes certain properties.

Once the inference module 240 has made a determination or assumption that certain application-oriented properties are present in the data being stored, the cache manager 119 will use the properties to affect caching functions. For example, the cache manager 119 can use this information to select an appropriate storage component (e.g., the SFPS 116, the LSPS 115, or both) for storing the data as explained above. In addition, the cache manager may determine when data stored in the SFPS 116 is to be written to the LSPS 115, or whether data should be evicted from the SFPS 116.

In other embodiments, after the property specifier 131 has identified the presence of certain attributes, the cache manager 119 uses the application-oriented properties to determine whether the application 130 has an interest in low latency (or whether the application 130 does not benefit from low latency), and selects a storage component based on this determination. If it is determined that the application 130 has no particular interest in low latency, then the data will be stored in the LSPS 115. On the other hand, if it is determined that the application 130 has a greater interest in low latency, then the SFPS 116 is chosen for storing the data.

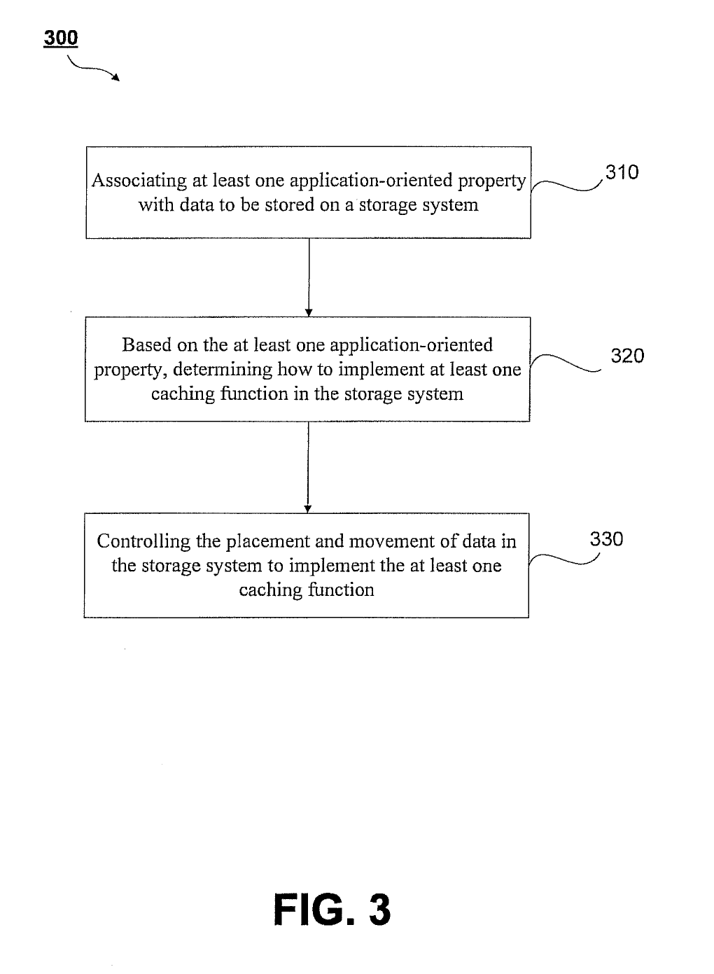

Referring to FIG. 3, a block/flow diagram 300 depicts an exemplary method for improving the efficiency of a storage system in accordance with the present principles. In block 310, at least one application-oriented property is associated with the data being stored in storage system 110. As explained above, the exemplary application-oriented property may indicate whether the data is transient, whether the data is part of a large stream of data, whether the data has an interest in low latency, whether certain attributes are present in the data based on the format of the data, etc.

As explained above, an application 130 may include a flag inserter 132 which can annotate the data with flags that serve to identify or associate particular attributes with the data. Alternatively, an inference module 240 located at the storage system 110 may infer or determine the presence of certain attributes or properties by scanning the content of I/O requests. Based upon the inferences or determinations made by the inference module 240, properties can be associated with the data.

The application-oriented properties that are associated with the data are used in block 320 to determine a manner of implementing at least one caching function in the storage. A number of different caching functions may be implemented in the storage system 110. For example, the caching functions implemented in storage system 110 may involve selecting one or more components (e.g., the SFPS 116, the LSPS 115, or both) to store the data, determining when data stored in a persistent cache component (e.g., SFPS 116) is to be transferred to a backing store component (e.g., LSPS 115), or determining when data should be evicted from a persistent cache component (e.g., SFPS 116).

The operations at block 320 may involve determining how one or more of these or other similar caching functions can be implemented in the storage system using the cache manager 119. For example, if the caching function involves selecting a component to store the data from a write request, then data may be stored in either the SFPS 116, the LSPS 115, or both. However, consider the case where the SFPS 116 is chosen to store the data, but there is not enough storage space available in the SFPS 116. In this case, the cache manager 119 may determine that other data stored in the SFPS 116 should be written to the LSPS 115 to free up space in the SFPS 116. Alternatively, the cache manager 119 may decide that the data should be written to the LSPS 115 rather than the SFPS 116.

Next, the determinations made in block 320 may be used to control the placement and movement of both the data which is the subject of a current write request as well as the data which is already stored on the storage system (block 330). Based on these determinations, the cache manger 119 may store data on one or more components, transfer data between components, delete data stored on the components, or provide for other caching functions.

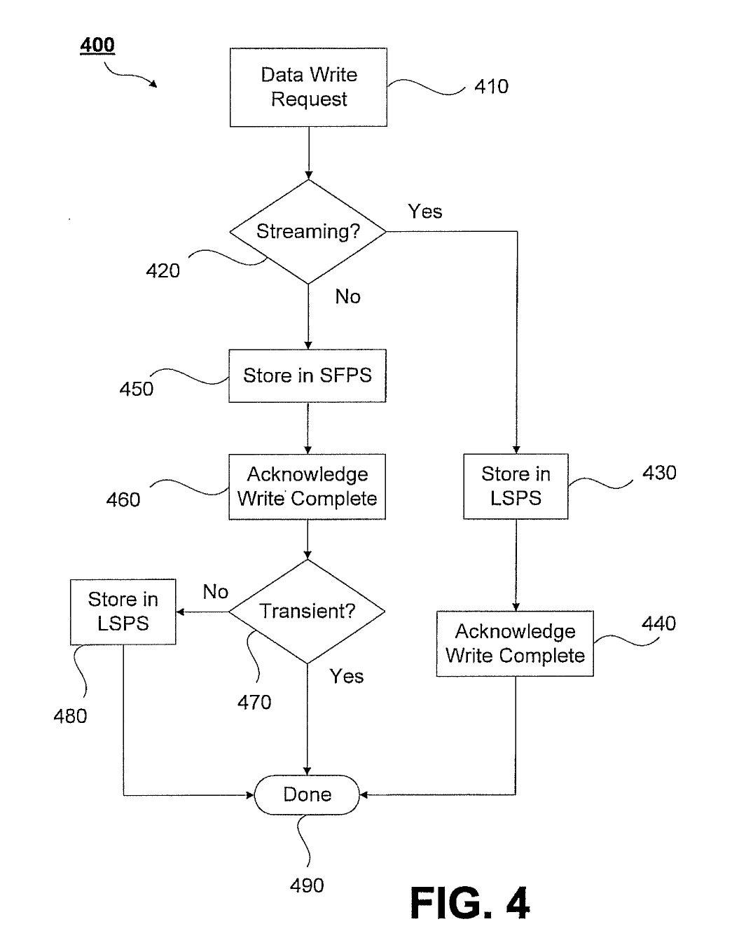

Referring to FIG. 4, a block/flow diagram illustrates an alternate method for improving the efficiency of a storage system in accordance with the present principles. Unlike the method disclosed above in FIG. 3, the method disclosed in FIG. 4 solely considers two attributes (i.e., streaming and transiency of data) in selecting an appropriate storage component for the data.

In block 410, a data write request is received by a storage system 110. The data is first checked to determine whether it is part of a stream (block 420). If so, the data is automatically stored in the LSPS 115 in block 430. After the data is stored in the LSPS 115, an acknowledgement that the data has been successfully stored is sent in block 440 and the process then comes to an end in block 490.

However, if it is determined that the data is not part of a data stream in block 420, the data is stored in the SFPS 116 (block 450). An acknowledgement that the data has been successfully stored is sent in block 460. At this point, a further determination is made as to whether or not the data is transient (block 470). If the data is transient, then it will be retained in the SFPS 116 until it is deleted and the process will end in block 490. Retaining transient data in SFPS 116 improves the performance of storage system 110 as explained above. Alternatively, if the data is not transient then it will be written to the LSPS 115 in block 480. Thus, for data which is neither streaming nor transient, the SFPS 116 improves performance of the system by serving as a cache. The process once again ends in block 490.

Having described preferred embodiments of a system and method for improving the efficiency of persistent caches (which are intended to be illustrative and not limiting), it is noted that modifications and variations can be made by persons skilled in the art in light of the above teachings. It is therefore to be understood that changes may be made in the particular embodiments disclosed which are within the scope of the invention as outlined by the appended claims. Having thus described aspects of the invention, with the details and particularity required by the patent laws, what is claimed and desired protected by Letters Patent is set forth in the appended claims.

What is claimed is:

1. A method for caching data in a storage system comprising at least one persistent cache component, comprising:
associating at least one application-oriented property with data to be stored on a storage system;
based on the at least one application-oriented property, determining a manner of implementing at least one caching function in the storage system; and
controlling data placement and data movement in the storage system to implement the at least one caching function.

2. The method of claim 1, wherein the at least one caching function involves selecting at least one component of the storage system to store the data.

3. The method of claim 1, wherein the at least one caching function involves determining when data stored in a persistent cache component is to be written to a backing store component of the storage system.

4. The method of claim 1, wherein the at least one caching function involves determining when data is to be evicted from a persistent caching component of the storage system.

5. The method of claim 1, wherein the application-oriented property indicates at least one of:
whether the data is transient; or
whether the data is part of a stream.

6. The method of claim 3, wherein data that is determined to be transient is not written to the backing store.

7. The method of claim 1, wherein an external application associates the at least one application-oriented property with the data by annotating the data with flags that reflect the at least one application-oriented property.

8. The method of claim 1, wherein an inference module located at the storage system associates the at least one application-oriented property with the data by inspecting contents of the data.

9. The method of claim 2, wherein selecting a storage component involves selecting a backing store component of the storage system to store the data if it is determined that the data is part of a stream.

10. The method of claim 2, wherein selecting a storage component involves selecting a persistent cache component of the storage system to store the data if it is determined that the data is transient.

11. A system for caching data in a storage system comprising at least one persistent cache component, comprising:
a property specifier for associating at least one application-oriented property with data to be stored on a storage system;
a cache manager configured to determine a manner for implementing at least one caching function in the storage system based on the at least one application-oriented property, and further configured to control data placement and data movement in the storage system to implement the at least one caching function.

12. The system of claim 11, wherein the at least one caching function involves selecting at least one component of the storage system to store the data.

13. The system of claim 11, wherein the at least one caching function involves determining when data stored in a persistent cache component is to be written to a backing store component of the storage system.

14. The system of claim 11, wherein the at least one caching function involves determining when data is to be evicted from a persistent caching component of the storage system.

15. The system of claim 11, wherein the application-oriented property indicates at least one of:
whether the data is transient; or
whether the data is part of a stream.

16. The system of claim 13, wherein data that is determined to be transient is not written to the backing store.

17. The system of claim 11, wherein an external application associates the at least one application-oriented property with the data by annotating the data with flags that reflect the at least one application-oriented property.

18. The system of claim 11, wherein an inference module located at the storage system associates the at least one application-oriented property with the data by inspecting contents of the content.

19. The system of claim 12, wherein selecting a storage component involves selecting a backing store component of the storage system to store the data if it is determined that the data is part of a stream.

20. The system of claim 12, wherein selecting a storage component involves selecting a persistent cache component of the storage system to store the data if it is determined that the data is transient.
